(19) United States
(12) Patent Application Publication
(10) Pub. No.: US 2014/0255940 A1
(43) Pub. Date: Sep. 11, 2014

(54) MULTI-WELL PLATE AND METHOD OF USE

(71) Applicant: HOLOGIC, INC., Marlborough, MA (US)

(72) Inventors: Raymond A. Jenoski, Boylston, MA (US); Steven A. Scampini, Groton, MA (US)

(73) Assignee: HOLOGIC, INC., Marlborough, MA (US)

(21) Appl. No.: 13/789,322

(22) Filed: Mar. 7, 2013

(51) Int. Cl. B01L 3/00

(52) U.S. Cl. CPC B01L 3/50855
USPC 435/6.12; 422/552; 435/305.2; 435/287.2

(57) ABSTRACT

A biological sample well plate includes a plate member having a top surface and a plurality of wells therein, each well being defined by an opening in the plate member top surface and an inner well surface that slopes downwardly to a well bottom having an upwardly extending projection, such that each well bottom of the plurality of wells defines a circumferential trough.

### FIELD

The present disclosure relates generally to devices for processing biological samples, more particularly, to multi-well plates and methods of using same.

### BACKGROUND

Many chemical, biological and biochemical reactions are carried out in containers, e.g. test tubes. Such reactions are amenable to automation and parallelization to increase throughput. Increasing throughput of such reactions, e.g., polymerase chain reactions used in diagnostic and screening tests, lowers the cost and increases the speed of the tests. Increasing automation also increases the reproducibility of these tests.

Multi-well plates allow many samples to be processed simultaneously or sequentially. As such, multi-well plates are used to automate these reactions. Multi-well plates are generally flat rectangular containers that include an ordered array of individual liquid reservoirs or “wells.” The Society for Laboratory Automation and Screening establishes the standards for multi-well plate geometry, including the positions of the wells on the plate. The most common multi-well plates have 96 and 384 wells. Regardless of the number of wells, a standard well plate measures approximately 128 mm (L) by 85 mm (W) by 14 mm (H). A 96 well plate has 8 rows of 12 wells. Multi-well plates having more wells maintain the 8 by 12 ratio of rows and columns found in the 96 well plate.

In both industry and academia, biochemical reactions are carried out on increasingly larger scales. Accordingly, increasing the number of wells per plate results in improved processes and systems. Plates with 864, 1,536, and even 9,600 wells are currently in use. Plates with more wells are able to handle more samples per test, and conduct test using smaller samples and less reagent.

However, squeezing more wells into a plate of a standardized size results in smaller wells. A decrease in well size leads to problems such as evaporation, inefficient mixing, uneven thermal conduction, and imprecise optical detection of reaction indicators. Many of these problems are exacerbated by air bubbles that may form as liquid is added to or manipulated in the wells. Many reactions carried out in multi-well plates, such as the polymerase chain reaction, require precise temperatures. Further, many tests and assays carried out in multi-well plates include spectroscopic indicators, e.g., colorimetric indicators, of results. Accordingly, a perceived problem with multi-well plates is the tendency of relatively large air bubbles to form in the liquids contained therein.

### SUMMARY

In one embodiment of the disclosed inventions, a biological sample well plate includes a plate member having a top surface and a plurality of wells therein, each well being defined by an opening in the plate member top surface and an inner well surface that slopes downwardly to a well bottom having an upwardly extending projection, such that each well bottom of the plurality of wells defines a circumferential trough. The upwardly extending projection of at least one well bottom is conical or spherical, or has an elliptical cross section.

In another embodiment of the disclosed inventions, a system for assaying a biological liquid sample includes a biological sample well plate including a plate member having a top surface and a plurality of wells therein, each well being defined by an opening in the plate member top surface and an inner well surface that slopes downwardly to a well bottom having an upwardly extending projection, such that each well bottom of the plurality of wells defines a circumferential trough; and a thermal processing unit thermally coupled to the well plate, and configured to change a temperature of a biological liquid sample contained in one or more wells of the plurality. The system may also include a spectrometer configured to measure a light property of the liquid sample in one of the wells.

In yet another method of the disclosed inventions, a method of assaying a plurality of liquid biological samples in a biological sample well plate includes introducing each of the plurality of liquid biological samples to a respective well of the plurality of well; and performing an assay on each of the liquid biological samples in its respective well. The biological sample well plate includes a plate member having a top surface and a plurality of wells therein, each well being defined by an opening in the plate member top surface and an inner well surface that slopes downwardly to a well bottom having an upwardly extending projection, such that each well bottom of the plurality of wells defines a circumferential trough. The method may also include thermally processing the liquid biological samples and/or optically processing the liquid biological samples.

Other and further aspects and features of embodiments of the disclosed inventions will become apparent from the ensuing detailed description in view of the accompanying figures.

### BRIEF DESCRIPTION OF THE DRAWINGS

The drawings illustrate the design and utility of embodiments of the disclosed inventions, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments of the disclosed inventions and are not therefore to be considered limiting of its scope.

FIG. 1A is a top view of a multi-well plate according to one embodiment of the disclosed inventions.

FIG. 1B is a side view of the multi-well plate depicted in FIG. 1A.

FIG. 2A is a cross-sectional view through the line 2-2 in the multi-well plate depicted in FIGS. 1A and 1B.

FIG. 2B is a detailed cross-sectional view of a portion of the multi-well plate depicted in FIGS. 1A and 1B through the line 2-2.

FIG. 3 is a detailed cross-sectional view of a portion of a prior art multi-well plate.

FIG. 4A is a detailed cross-sectional view of a portion of a prior art multi-well plate, after a liquid has been added to a well and an air bubble has formed in the well bottom.

FIG. 4B is a detailed cross-sectional view of a portion of the multi-well plate depicted in FIGS. 1A and 1B through the line 2-2, after a liquid has been added to a well and an air bubble has formed in the well bottom.

### DETAILED DESCRIPTION OF THE ILLUSTRATED EMBODIMENTS

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

Various embodiments of the disclosed inventions are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention, which is defined only by the appended claims and their equivalents. In addition, an illustrated embodiment of the disclosed inventions needs not have all the aspects or advantages shown. An aspect or an advantage described in conjunction with a particular embodiment of the disclosed inventions is not necessarily limited to that embodiment and can be practiced in any other embodiments even if not so illustrated.

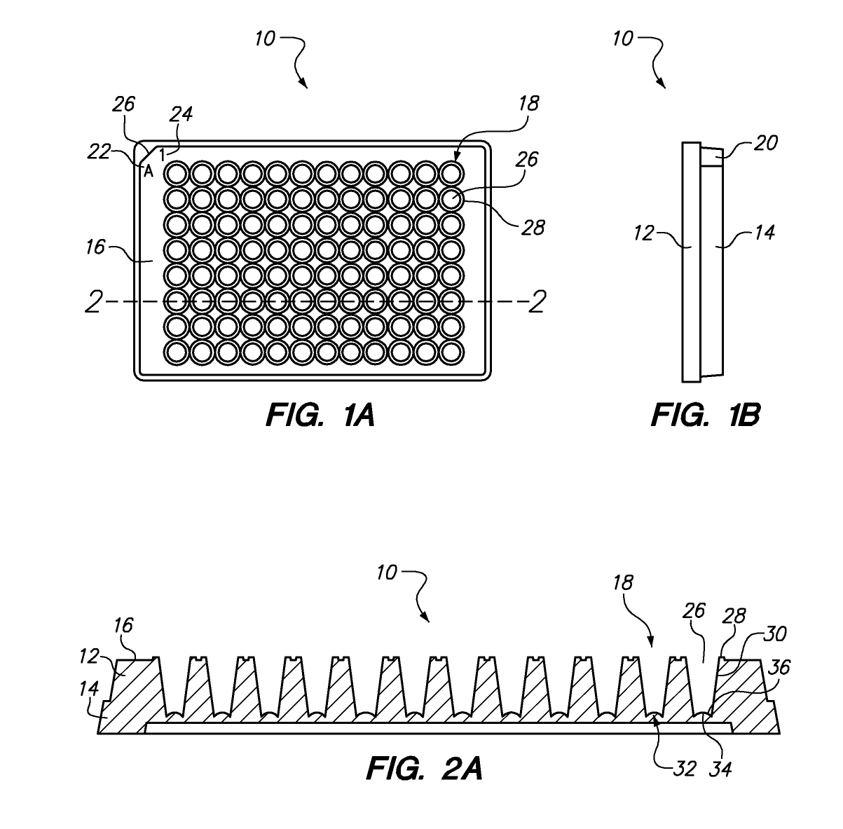

FIGS. 1A and 1B depict a multi-well plate 10 according to an embodiment of the disclosed inventions. The plate 10 is a rectangular prism with rounded corners measuring approximately 128 mm (L) by 85 mm (W) by 14 mm (H). As shown in FIG. 1B, the plate has two layers, a top layer 12 and a bottom layer 14. As shown in FIG. 1A, the top layer 12 of the plate 10 has a generally planar top surface 16 and a plurality of wells 18 defined therein. The top layer 12 of the plate 10 may optionally include an alignment feature 20, which is a blunted corner. This alignment feature 20 allows manual users and automated devices to easily and quickly identify the blunted corner of the plate 10, thereby orienting and aligning the plate 10. The top surface 16 may also include row and column indicators 22, 24.

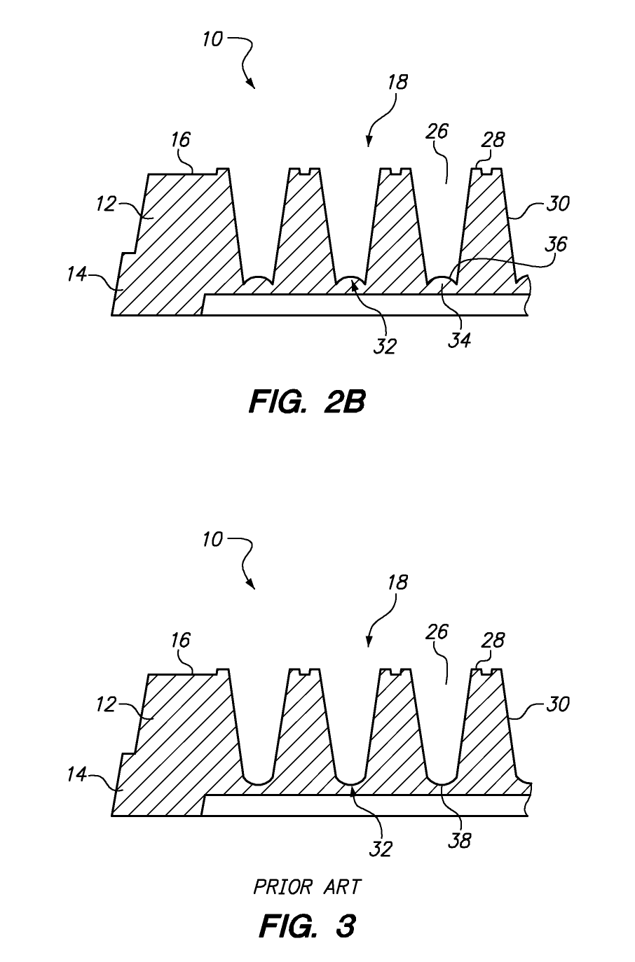

FIGS. 2A and 2B depict a cross-section through the line 2-2 in the plate 10 depicted in FIGS. 1A and 1B. Each well 18 defines an opening 26 in the top surface 16 of the plate 10 and extends into the top and bottom layers 12, 14 of the plate 10. A rim 28 on the top surface 16 surrounds each opening 26. Each well 18 has a side wall 30, which slopes downwardly and radially inwardly toward the well bottom 32. Each well bottom 32 includes an upwardly extending projection 34, which defines a circumferential trough 36 in the well bottom 32.

FIG. 3 depicts a prior art multi-well plate 10 in a cross sectional view similar to the view in FIG. 2B. Other than the well bottom 32, the prior art plate 10 depicted in FIG. 3 is similar to the plate 10 depicted in FIG. 2B. While the plate 10 depicted in FIG. 2B has an upwardly extending projection 34 in its well bottom 32, the prior art plate 10 depicted in FIG. 3 has a conventional well bottom 32, which includes a concave spherical surface 38.

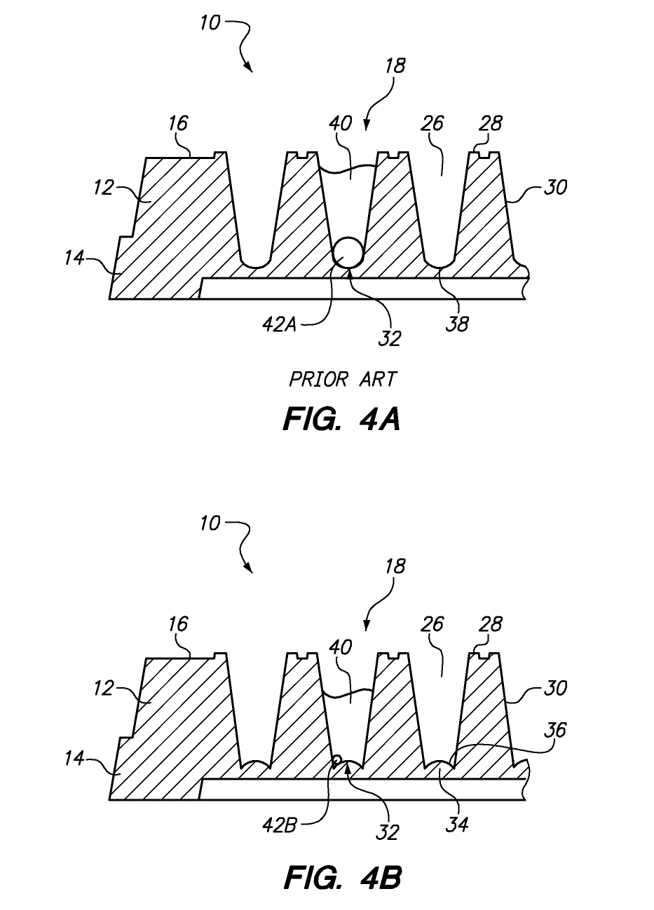

FIG. 4A depicts the prior art multi-well plate 10 in FIG. 3 after a volume (V) of liquid 40 has been added to a well 18 therein. In some instances, when liquid 40 is added to (or manipulated in) a well 18 in a prior art plate 10, an air bubble 42A will form in the concave well bottom 32 and remain therein. FIG. 4B depicts a multi-well plate 10 according to an embodiment of the disclosed inventions after the same volume (V) of liquid 40 has been added to a well 18 therein. Due to the presence of the upwardly extending projection 34 and the circumferential trough 36 in the well bottom 32 of the plate 10 depicted in the FIG. 4B, the air bubble 42B formed therein is smaller than the air bubble 42A formed in the concave well bottom 32 of the conventional plate 10 depicted in FIG. 4A.

The larger air bubble 42A in the conventional plate 10 raises the liquid level in the well 18 depicted in FIG. 4A compared to the liquid level in the well 18 depicted in FIG. 4B, thereby increasing the surface area of the liquid 40 exposed to atmosphere in FIG. 4A (in a conventional conical well 18). The increased exposed surface area of the liquid 40 in FIG. 4A, in turn, increases evaporation in the conventional plate 10 depicted in FIG. 4A compared to the plate 10 depicted in FIG. 4B. Further, because bubble formation is unpredictable, the evaporation rate will vary from well to well in the plate 10 depicted in FIG. 4A to a greater extent than in the plate 10 depicted in FIG. 4B. Evaporation of liquids affects almost all chemical, biological, and biochemical reactions by changing the concentration of substances in the liquid 40.

Because liquids generally conduct heat more efficiently than air, the different sizes of air bubbles 42A, 42B in the plates depicted in FIGS. 4A and 4B results in more uneven thermal conduction in the plate 10 depicted in FIG. 4A, which has larger air bubbles 42A than those formed in the plate 10 depicted in FIG. 4B. Consistent thermal conduction is essential to temperature sensitive reactions, like the polymerase chain reaction.

Air bubbles also affect the transmission of light. Therefore, the different sizes of air bubbles 42A, 42B in the plates depicted in FIGS. 4A and 4B results in less accurate optical detection of reaction indicators in the plate depicted in FIG. 4A, which has larger air bubbles 42A than those formed in the plate 10 depicted in FIG. 4B.

The multi-well plates 10 of the disclosed invention can be made, for instance, by injection molding of polymer. Suitable polymers include polypropylene, polycarbonate, cyclo-olefin polymers and copolymers, fluoropolymers, and polyvinyl chloride. Optionally, additives, such as thermally conducive additives and pigments, can be added to the polymer during injection molding. The plate can be injection molded as a unitary body. Alternatively, different portions of the plates 10, e.g., the top and bottom layers 12, 14, can be made separately and subsequently attached to each other, e.g. by an adhesive. Different portions of the plate 10 can be made from different materials, such as polymers, metals, and ceramics.

The bottom well portions 32 can have substantial transmittance at wavelengths that may be used in assays for which the plate 10 is designed, e.g., 200 nm to 800 nm. The side walls 30 can be substantially opaque in those same wavelengths. The side walls 30 can be opacified by adding a dark pigment during injection molding.

Multi-well plates 10 may be used with automated systems including liquid dispensing, withdrawing and mixing devices, thermal block heat exchangers, and spectrophotometers. A thermal block heat exchanger includes a “block” made from a thermally conductive material such as metal, e.g. aluminum. The block may have a flat surface in contact with the flat bottom of the plate 10, or it may have wells of its own for contact the undulating bottom surface with plates that expose the exteriors of the well bottoms (not shown). In either case, consistent thermal contact between the block and the plate 10 enables the thermal block heat exchanger to predictably affect the temperature of a sample being processed in the plate 10 by either adding heat to or removing heat from the thermal block.

Spectrophotometers detect the spectra of light passing through, whether directly or reflected, the sample in the plate 10. Spectral information can be used to determine the state or result of the reactions in the plate 10.

Although, the wells 18 depicted in FIGS. 2A, 2B, and 4B are generally conical and have well bottoms 32 including a spherical upwardly extending projection 34, the following claims encompass any side wall 30 and upwardly extending projection 34 geometry.

Although particular embodiments of the disclosed inventions have been shown and described herein, it will be understood by those skilled in the art that they are not intended to limit the present inventions, and it will be obvious to those skilled in the art that various changes and modifications may be made (e.g., the dimensions of various parts) without departing from the scope of the disclosed inventions, which is to be defined only by the following claims and their equivalents. The specification and drawings are, accordingly, to be regarded in an illustrative rather than restrictive sense. The various embodiments of the disclosed inventions shown and described herein are intended to cover alternatives, modifications, and equivalents of the disclosed inventions, which may be included within the scope of the appended claims.

1-4. (canceled)

5. A system for assaying a biological liquid sample, comprising:
a biological sample well plate including a plate member having a top surface and a plurality of wells therein, each well being defined by an opening in the plate member top surface and an inner well surface that slopes downwardly to a well bottom having an upwardly extending projection, such that each well bottom of the plurality of wells defines a circumferential trough; and
a thermal processing unit thermally coupled to the well plate, and configured to change a temperature of a biological liquid sample contained in one or more wells of the plurality.

6. The system of claim 5, further comprising a spectrometer configured to measure a light property of the liquid sample in one of the wells.

7-9. (canceled)

10. The system of claim 5, wherein the upwardly extending projection of at least one well bottom is conical.

11. The system of claim 5, wherein the upwardly extending projection of at least one well bottom has an elliptical cross section.

12. The system of claim 5, wherein the upwardly extending projection of at least one well bottom is spherical.
